(19) United States
(12) Patent Application Publication
(10) Pub. No.: US 2021/0375148 A1
(43) Pub. Date: Dec. 2, 2021

(54) SYSTEM AND METHOD FOR AUTONOMOUS LEARNING OF CONTENTS USING A MACHINE LEARNING ALGORITHM

(71) Applicant: FOUNTECH SOLUTIONS LIMITED, Limassol (CY)

(72) Inventors: Nick Kairinos, Limassol (CY); Petros Mina, Nicosia (CY)

(73) Assignee: FOUNTECH SOLUTIONS LIMITED, Limassol (CY)

(21) Appl. No.: 17/318,094

(22) Filed: May 12, 2021

Related U.S. Application Data
(60) Provisional application No. 63/033,455, filed on Jun. 2, 2020.

(51) Int. Cl. G09B 5/06; G06N 5/02; G06N 20/00; G06F 16/248

(52) U.S. Cl. CPC G09B 5/065; G06F 16/248; G06N 20/00; G06N 5/025

(57) ABSTRACT

A method of autonomous learning of contents using a machine learning model, wherein in the method includes processing a corpus of data using the machine learning model to extract insights including at least one of a key knowledge, a topic of knowledge, a plurality of key entities, or an associated cognitive ability, collectively referred to as meta-tags; creating associations between a plurality of sub-components of at least one of an existing content, an enriched content, or one or more meta-tags, using the machine learning model to generate a graph knowledge base; and automatically performing at least one of: 1) building the graph knowledge base or 2) enriching an existing knowledge base, using the machine learning model and the one or more meta-tags, wherein the graph knowledge base comprises at least a graph form of information, wherein the graph knowledge base enables automatic retrieval of organized content to be used for generating teaching material for the user based on the one or more meta-tags.

### TECHNICAL FIELD

The present disclosure relates generally to autonomous learning and organisation of content using a machine learning model; Moreover, the aforesaid system employs, when in operation, machine learning techniques for autonomous organisation and learning.

### BACKGROUND

Education is the process of facilitating learning, or the acquisition of knowledge, skills, values, beliefs, and habits. Typically used educational techniques include for example, storytelling, discussion, teaching, training, and directed research. Education frequently takes place under the guidance of educators, but learners may also educate themselves. Education can take place in formal or informal settings and any experience that has a formative effect on the way one thinks, feels, or acts may be considered educational.

Existing education system follows ‘one teacher, one room, one chalkboard’ method of teaching which is no longer appropriate as each learner has their own learning capabilities and influenced by their upbringing and background. For many centuries, mankind has struggled to address the above problem of teaching the same content to learners who have different learning capabilities.

Over the years, many online teaching software programs have been developed for teaching lessons to a learner. However, most of these teaching programs are not as effective as they teach an entire topic automatically by presenting it to the learner. The existing teaching methods require manual organization and categorization of materials and assembling the students on a single platform for teaching. The educator or teacher need to organize and categorize the materials for teaching various topics and assemble the material in an optimal manner depending on the preference and learning abilities of students. The current educational systems do not enable organizing and categorizing the materials for teaching various topics autonomously. Typically, the teachers or the educators need to spend a lot of time preparing the materials for teaching various topics in a preferred mode of teaching for each of the students.

Therefore, in light of the foregoing discussion, there exists a need to address the aforementioned drawbacks in existing methods and systems due to their inability to autonomously create and organize learning content related to a specific topic of interest to a user and personalize to suit the interest and learning capabilities of the user.

### SUMMARY

The present disclosure provides a method of autonomous organisation of educational content using a machine learning model, characterized in that the method comprising:

processing a corpus of data using the machine learning model to extract insights comprising at least one of a key knowledge, a topic of knowledge, a plurality of key entities, or an associated cognitive ability, collectively referred to as meta-tags;

creating associations between a plurality of sub-components of at least one of an existing content, or one or more meta-tags, using the machine learning model to generate a graph knowledge base; and

automatically performing at least one of: 1) building the graph knowledge base or 2) enriching an existing knowledge base, using the machine learning model and the one or more meta-tags,

wherein the graph knowledge base comprises at least a graph form of information, wherein the graph knowledge base enables automatic retrieval of organized content to be used for generating teaching material for the user based on the one or more meta-tags.

The present disclosure also provides a system comprising a server and a user interface for autonomous organisation of contents using a machine learning model, comprising:

a memory that stores a set of instructions and an information associated with a machine learning algorithm; and

a processor that executes the set of instructions via a plurality of modules comprising:
a data extraction module implemented by the processor and configured to extract a corpus of data using the machine learning model, wherein the corpus of data comprises at least one of a key knowledge, a topic of knowledge, a plurality of key entities, or an associated cognitive ability, collectively referred to as meta-tags;
a data processing module implemented by the processor configured to process the corpus of data using the machine learning model to extract insights comprising at least one of the key knowledge, the topic of knowledge, the plurality of key entities, or the associated cognitive ability, collectively referred to as the meta-tags; and
a knowledge base generation module implemented by the processor and configured to perform:
   creating associations between a plurality of sub-components of at least one of an existing content, an enriched content, or one or more meta-tags, using the machine learning model to generate a graph knowledge base; and
   automatically performing at least one of: 1) building the graph knowledge base or 2) enriching an existing knowledge base, using the machine learning model and the one or more meta-tags,

wherein the graph knowledge base comprises at least a graph form of information, and wherein the graph knowledge base enables automatic retrieval of organized content to be used for generating teaching material for the user based on the one or more meta-tags.

Embodiments of the present disclosure substantially eliminate or at least partially address the aforementioned problems due to their inability to automatically assimilate and categorize teaching content based on interest and learning capabilities of a user, with minimal user intervention and validation.

Additional aspects, advantages, features and objects of the present disclosure are made apparent from the drawings and the detailed description of the illustrative embodiments construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art

will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system, in accordance with an embodiment of the present disclosure;

FIG. 2 is a functional block diagram of a system, in accordance with an embodiment of the present disclosure;

FIG. 3 is a flow diagram depicting a process of retrieval of information by a user from at least one of a database, a graph knowledge base or a persistent form of information in accordance with an embodiment of the present disclosure;

FIG. 4 is an exemplary view of a graphical user interface that shows query and retrieval of an organized content in accordance with an embodiment of the present disclosure; and

FIG. 5 is a flow diagram illustrating a method of autonomous organisation of content using a machine learning model, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present disclosure provides a method of an autonomous organisation of content using a machine learning model, characterized in that the method comprises:

processing a corpus of data using the machine learning model to extract insights comprising at least one of a key knowledge, a topic of knowledge, a plurality of key entities, an associated cognitive ability, collectively referred to as meta-tags;

creating associations between a plurality of subcomponents of at least one of an existing content, or one or more meta-tags, using the machine learning model to generate a graph knowledge base; and

automatically performing at least one of: 1) building the graph knowledge base or 2) enriching an existing knowledge base, using the machine learning model and the one or more meta-tags,

wherein the graph knowledge base comprises at least a graphical form of information, wherein the graph knowledge base enables automatic retrieval of organized content to be used for generating teaching material for the user based on the one or more meta-tags.

The present method dynamically organizes information related to the content in an autonomous way from any corpus of data/knowledge (such as, for example, data available on various searchable databases accessible via the internet or information found in book form). The present method

employs a variety of machine learning methods to organize the information. The machine learning model may perform at least one of (i) recognition of relevant information in the body of knowledge, (ii) creation of meta-tags by processing information found within the body of knowledge, (iii) enrichment of the existing content with additional information from at least one of the body of knowledge in at least one of a database, a graph knowledge base, or a persistent form of information, (iv) recognition of cognitive skill required to understand the body of knowledge, or (v) recognition of relations between components of the unorganized knowledge.

The present method provides information related to the topic to help the user to improve their teaching on the content. The present method further provides personalized content related to the topic in a selected medium (for example, a video, a text, an image etc.) based on the pace of understanding of the user by utilising information found in the graph knowledge base such as that of meta-tags that describe the required learner cognitive skills relevant to the content.

In an embodiment, the machine learning model retrieves corpus of data from a plurality of data sources and processes the corpus of data for extracting insights comprising at least one of a key knowledge, a topic of knowledge, a plurality of key entities, or an associated cognitive ability, collectively referred to as meta-tags. The present method optionally enriches at least one of an existing database, an existing graph knowledge base, an existing persistent form of information with the categorized base data and organises them based on at least one of the one or more meta-tags, cognitive skill or learning ability of the user in an autonomous manner. The graph knowledge base includes at least a graph form of information and enables automatic retrieval of organized content to be used for generating teaching material for the user based on the one or more meta-tags.

In an embodiment, the machine learning algorithm may include a self-dynamically driven algorithm that may be used to dynamically scale the cognitive skill or learning ability of the user on the content selected by the user or based on content of interest to the user and the details of which could be acquired for example by the machine learning algorithm based on capturing a user response to an activity or monitoring user activity or inputs on a user interface, a user interaction with a learning material, and using various other techniques that can automatically capture a topic of interest to the user. In an embodiment, the graph knowledge base for the user may be dynamically built or an existing graph knowledge base may be enriched based on a profile of the user (e.g. based on educational details of the user).

In an embodiment, the user may be a student, a learner, a researcher, a teacher or an employee of a company. The content that is accessed by the user may be stored in an external database. In an embodiment, the acquired corpus of data is processed to generate a graph knowledge base based on the insights generated when processing the provided corpus. The insights can be in the form of meta-tags.

According to an embodiment, the enriched content is obtained by enriching the existing content in at least one of a database, the graph knowledge base or a persistent form of information, with an additional content using the one or more meta-tags as a search term in at least one of the database, the graph knowledge base, or the persistent form of information, using the machine learning model and the one or more meta-tags and wherein creating associations includes creating associations between a plurality of sub-components of at least one of the existing content, the enriched content, or the one or more meta-tags, using the machine learning model to generate the graph knowledge base.

The present method enables the user to create own lessons (e.g. teaching material) based on a content selected by the user, by retrieving the information from at least one of the database, the graph knowledge base or the persistent form of information using search queries and the one or more meta-tags.

According to yet another embodiment, the content associated with the graph knowledge base is arranged in the form of a plurality of nodes and a plurality of connected edges implying an association between the plurality of nodes.

According to yet another embodiment, the one or more meta-tags is an indicator of cognitive skills of the user.

According to yet another embodiment, the corpus of data is made available to the machine learning algorithm by at least one of a terminal user, a second database, or a second user.

According to yet another embodiment, the graph knowledge base is enriched based on a digital content made available to the machine learning algorithm by at least one of a terminal user, a second database, or a second user.

According to another embodiment, the method builds or enriches the graph knowledge base from scratch using digital content made available by the user. The present method may build or enrich the graph knowledge base using a content provided by the user.

According to yet another embodiment, the present method may enable the user to access a specific category of interest in the graph knowledge base using a specific query.

According to yet another embodiment, the query is an indicator of at least one of a subject of interest, a cognitive skill level associated with the subject of interest, or a medium of presentation. The present method may retrieve teaching content from the graph knowledge base based on at least one of the query, the cognitive skill, and the learning ability requested by the user and may provide a personalized teaching content to the user. The personalized teaching content is associated at least with a personalized theme based on the cognitive skill or the learning ability requested by the user.

According to yet another embodiment, the subject of interest may include a teaching content related to a particular subject and associated with a particular level of difficulty/cognitive skill of the user. For example, if the user intends to create a personalized teaching material on a topic such as physics of lights, the method recognizes the category of physics and the subcategory of lights and brings related material organized as “the properties of light”, “the properties of electromagnetic waves”, “how light bulbs work” etc.

According to yet another embodiment, the method comprises enabling the user to generate the personalized teaching material from the graph knowledge base using a user interface of a user device.

According to yet another embodiment, the plurality of data sources comprises at least one of textbooks, online databases, other available databases, websites or e-books.

According to yet another embodiment, the method comprises translating the data in the graph knowledge base for the user prior to presenting it to the user.

According to yet another embodiment, the method comprises determining behavioral pattern of the user by analyzing the content. A machine learning model can be a mathematical representation of a real-world process. The machine learning algorithm finds patterns in training data

such that input parameters correspond to desired output valves. The output of the training process is a machine learning model which can be used to make predictions or deliver insights. In an embodiment, the present method may provide a gamification content related to the content to the user. According to yet another embodiment, at least one of the records, history or preferences of the user is obtained from the user to determine the cognitive skill or learning ability of the user.

In one embodiment, the autonomous learning of contents provided by the user using the machine learning model may help the user to improve his knowledge on the particular content and may also help the user to enhance his preparation for exams.

In an embodiment, the present method implements a blockchain-based system for operations to carry through with transactions such as at least one of the payments or the issue of certificates. The blockchain enablesthe user to enter into a transparent and provenance transaction. The blockchain further enables the user to implement an independent transaction with other users. The blockchain creates custom cryptocurrencies to handle grants or voucher-based funders of education in many countries. The blockchain stores records of the transaction related to the users and the records are isolated from the modification. In anembodiment, the blockchain automatically verifies a validity of a certificate associated with the user that is issued by an organization without the intervention of the organization.

The present disclosure also provides a system comprising a server and a user interface for autonomous organisation of contents using a machine learning model, the server comprising:

a memory that stores a set of instructions and an informationassociated with a machine learning algorithm; and

a processor that executes the set of instructions via a plurality of modules comprising:
a data extraction module implemented by the processor and configured to extract a corpus of data using the machine learning model, wherein the corpus of data comprises at least one of a key knowledge, a topic of knowledge, a plurality of key entities, or an associated cognitive ability, collectively referred to as meta-tags;
a data processing module implemented by the processor configured to process the corpus of data using the machine learning model to extract insights comprising at least one of the key knowledge, the topic of knowledge, the plurality of key entities, or the associated cognitive ability, collectively referred to as the meta-tags; and
a knowledge base generation module implemented by the processor and configured to perform:
   creating associations between a plurality of sub-components of at least one of an existing content, an enriched content, and one or more meta-tags, using the machine learning model to generate a graph knowledge base; and
   automatically performing at least one of: 1) building the graph knowledge base or 2) enriching an existing knowledge base, using the machine learning model and the one or more meta-tags and provided corpus,

wherein the graph knowledge base comprises at least a graph form of information, and wherein the graph knowledge base enables automatic

retrieval of organized content to be used for generating teaching material for the user based on the one or more meta-tags.

The advantages of the present system are thus identical to those disclosed above in connection with the present method and the embodiments listed above in connection with the method apply mutatis mutandis to the system.

### DETAILED DESCRIPTION OF THE DRAWINGS

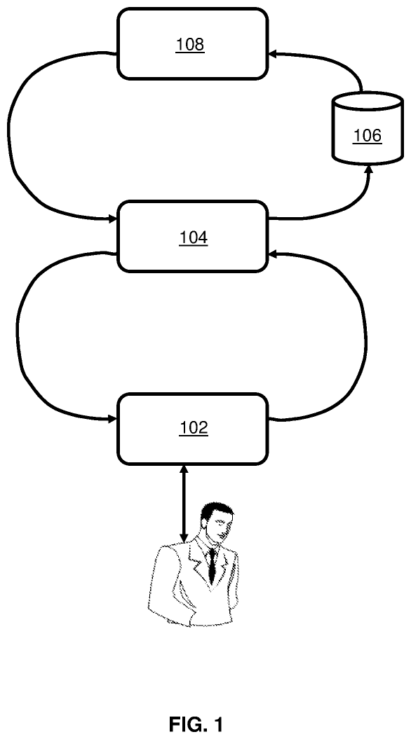

FIG. 1 is a schematic illustration of a system in accordance with an embodiment of the present disclosure. The system comprises a user interface 102, a server 104, a server database 106 and a machine learning component 108. The machine learning component 108 comprises a machine learning model. The server 104 obtains a corpus of data from a plurality of data sources. The data sources may include, for example, an online library of resources, research materials, e-books, websites, and the like. The server 104 processes the corpus of data using the machine learning model to generate insights comprising at least one of a key knowledge, a topic of knowledge, a plurality of key entities, or an associated cognitive ability, collectively referred to as meta-tags to generate a graph knowledge base comprising relations between the corpus of data and the generated insights. The server 104 creates associations between a plurality of sub-components of at least one of an existing content, an enriched content, or one or more meta-tags to generate a graph knowledge base using the machine learning model. The server 104 automatically performs at least one of: 1) building the graph knowledge base or 2) enriching an existing knowledge base using the machine learning model and the one or more meta-tags. The graph knowledge base includes at least a graph form of information and enables automatic retrieval of organized content to be used for generating teaching material for the user based on the one or more meta-tags. The content associated with the graph knowledge base is

arranged in the form of a plurality of nodes and a plurality of connected edges implying an association between the plurality of nodes.

The persistent form of information includes, for example, Sentences or paragraphs of text, images, videos, gamification material, or other teaching material as nodes of information that are persisted in plain or encoded form. Furthermore, the nodes of information are additionally enriched with meta-tags, generated by a machine learning model, that provide insight to the information contained within such nodes. Furthermore, the information itself or the meta-tags can be used to associate relevant information together via the creation of edges between the nodes.

The graph knowledge base is enriched based on a digital content made available to the machine learning algorithm by at least one of a terminal user, a second database, or a second user.

The server 104 may store a graph form of information in the graph knowledge base. In an embodiment, the server 104 comprises the server database 106 and the machine learning component 108. The server 104 enables automatic retrieval of organized content to be used for generating teaching material for the user based on the one or more meta-tags, using the machine learning component 108, by analysing a user enquiry and comparing it with analytical insights, where the latter is achieved by adding at least one meta-tag to the corpus of data.

Notwithstanding the above, the information may also be organised in other forms of persistent information such as non-graph databases. A non-limiting example is that of a relational database that organises information in the form of rows and columns, where rows usually provide information under organised headings (the columns).

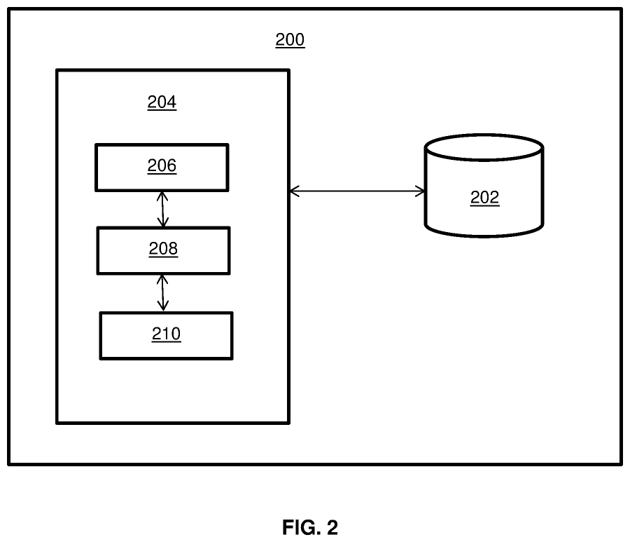

FIG. 2 is a functional block diagram of a system in accordance with an embodiment of the present disclosure. The functional block diagram of the

system comprises a server 200 comprising a memory 202 and a processor

204. The processor 204 includes a data extraction module 206, a data processing module 208, and a knowledge base generation module 210. These modules function as has been described in the main body of text.

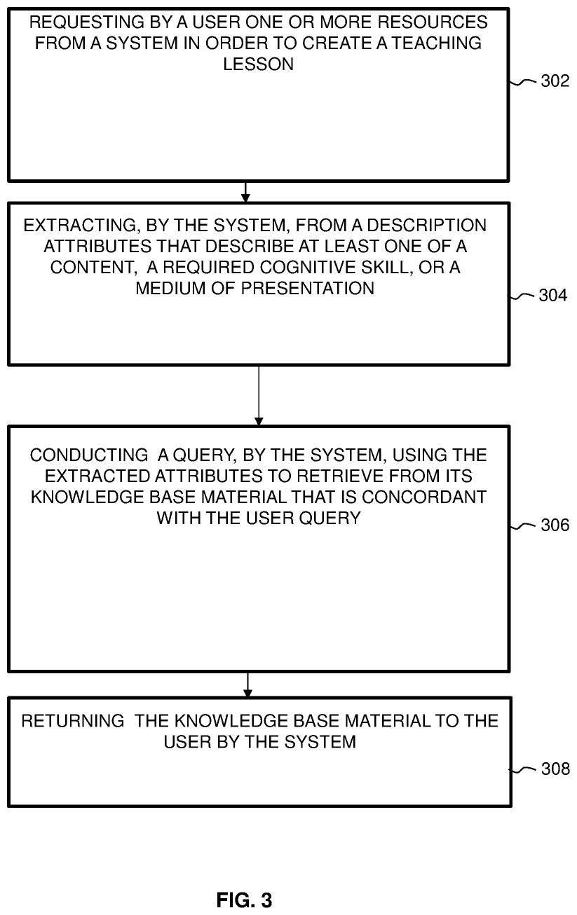

FIG. 3 is a flow diagram depicting a process of retrieval of information by a user from at least one a database, a graph knowledge base or a persistent form of information in accordance with an embodiment of the present disclosure. At step 302, the user requests from the system, one or more resources in order to create a teaching lesson. The user requests a teaching material that may be described by the content, the cognitive skill, the relevance to the query, the medium of presentation. The user request may be carried out using at least one of natural languages provided by a voice or a text, filters present on user interfaces or a dynamic assistance. At step 304, the system extracts, from the description, the attributes that describe at least one of the content, the required cognitive skill of the user, or the medium of presentation. Alternatively, the system takes as an input from the user interface relevant activated search filters that the user may have used. At step 306, the system conducts a query using the extracted attributes to retrieve from its knowledge base material that is concordant with the user query. At step 308, the system returns the knowledge base material to the user optionally along with information on how the knowledge base material is associated between it and/or to the query.

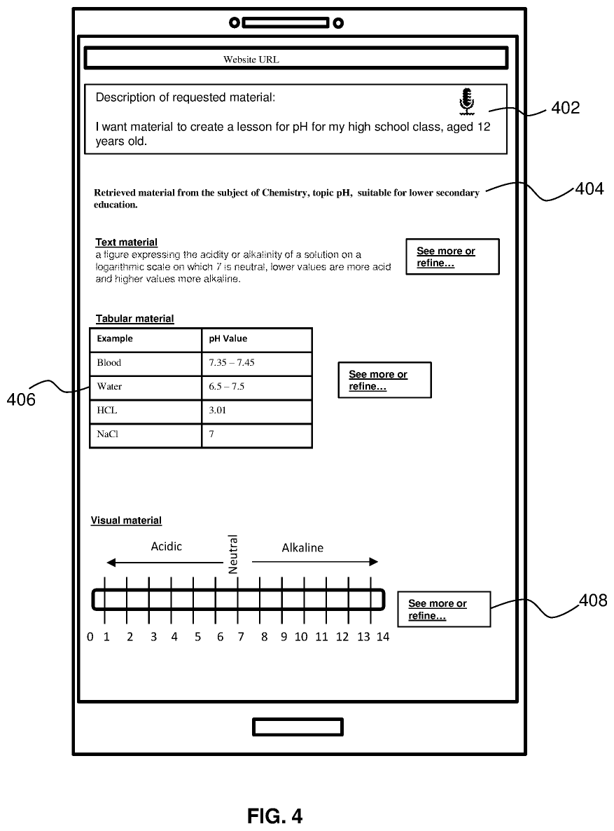

FIG. 4 is an exemplary view of a graphical user interface that shows a query and retrieval of an organized content in accordance with an embodiment of the present disclosure. The graphical user interface comprises a description field 402 that provides a way of interrogating the database using input from the user interface in the form of natural language, including the ability to do so via audio. The graphical user interface comprises a material field 404 that presents the system's understanding of the requested material. The graphical user interface comprises a presentation field 406 that

presents an appropriate teaching material as retrieved from the system's knowledge base. The user can use the graphical interface comprising of a retrieval field 408 to retrieve more results or refine their search.

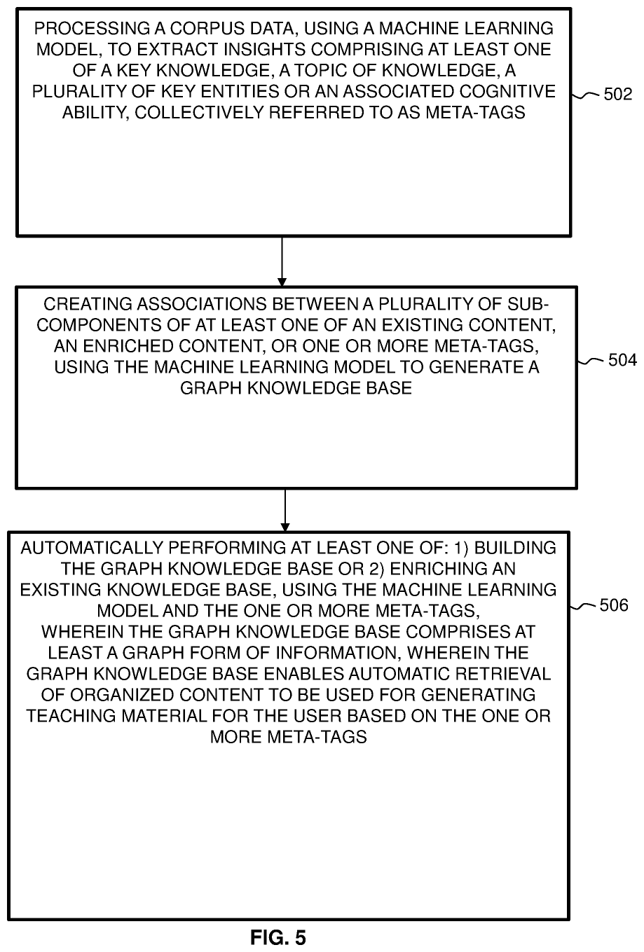

FIG. 5 is a flow diagram illustrating a method of an autonomous organisation of content using a machine learning model, in accordance with an embodiment of the present disclosure. At step 502, a corpus of data is processed using the machine learning model to extract insights comprising at least one of a key knowledge, a topic of knowledge, a plurality of key entities, or an associated cognitive ability, collectively referred to as meta-tags. At a step 504, an association between a plurality of sub-components of at least one of an existing content, an enriched content, or one or more meta-tags are created using the machine learning model to generate a graph knowledge database. At step 506, at least one of 1) building the graph knowledge base or 2) enriching an existing knowledge base is performed automatically using the machine learning model and the one or more meta-tags.

The graph knowledge base comprises at least a graph form of information and the graph knowledge base enables automatic retrieval of organized content to be used for generating teaching material for the user based on the one or more meta-tags.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method of an autonomous organisation of content using a machine learning model, wherein the method comprises:
processing a corpus of data using the machine learning model to extract insights comprising at least one of a key knowledge, a topic of knowledge, a plurality of key entities, or an associated cognitive ability, collectively referred to as meta-tags;
creating associations between a plurality of sub-components of at least one of an existing content, or one or more meta-tags, using the machine learning model to generate a graph knowledge base; and
automatically performing at least one of: 1) building the graph knowledge base or 2) enriching an existing knowledge base, using the machine learning model and the one or more meta-tags,
wherein the graph knowledge base comprises at least a graph form of information, wherein the graph knowledge base enables automatic retrieval of organized content to be used for generating teaching material for the user based on the one or more meta-tags.

2. The method of claim 1, wherein the method further comprises enriching the existing content in at least one of a database, the graph knowledge base or a persistent form of information, with an additional content using the one or more meta-tags as a search term in at least one of the database, the graph knowledge base, or the persistent form of information, using the machine learning model and the one or more meta-tags and wherein
creating associations includes creating associations between a plurality of sub-components of at least one of the existing content, the enriched content, or the one or more meta-tags, using the machine learning model to generate the graph knowledge base.

3. The method of claim 1, wherein the content associated with the graph knowledge base is arranged in the form of a plurality of nodes and a plurality of connected edges implying an association between the plurality of nodes.

4. The method of claim 1, wherein the one or more meta-tags is an indicator of cognitive skills of the user.

5. The method of claim 1, wherein the corpus of data is made available to the machine learning algorithm by at least one of a terminal user, a second database, or a second user.

6. The method of claim 1, wherein the graph knowledge base is enriched based on a digital content made available to the machine learning algorithm by at least one of a terminal user, a second database, or a second user.

7. The method of claim 1, further comprising:
receiving a query by the user, wherein the query is an indicator of at least one of: a subject of interest, a cognitive skill level associated with the subject of interest, and a medium of presentation;
retrieving learning content from the graph knowledge base based on at least one of the query, the cognitive skill, and the learning ability requested by the user; and
providing a personalized learning content to the user, wherein the personalized learning content is associated at least with a personalized theme based on the cognitive skill or learning ability requested by the user.

8. The method of claim 7, wherein the subject of interest may comprise a learning content related to a particular subject and associated with a particular level of difficulty/cognitive skill of the user.

9. A system comprising a server and a user interface for autonomous learning of contents using a machine learning model, t h e server comprising:
a memory that stores a set of instructions and information associated with a machine learning algorithm; and
a processor that executes the set of instructions via a plurality of modules comprising:
a data extraction module implemented by the processor and configured to extract a corpus of data using the machine learning model, wherein the corpus of data comprises at least one of a key knowledge, a topic of knowledge, a plurality of key entities, or an associated cognitive ability, collectively referred to as meta-tags;
a data processing module implemented by the processor configured to process the corpus of data using the machine learning model to extract insights comprising at least one of the key knowledge, the topic of knowledge, the plurality of key entities, or the associated cognitive ability, collectively referred to as the meta-tags; and
a knowledge base generation module implemented by the processor and configured to:
create associations between a plurality of sub-components of at least one of an existing content, or one or more meta-tags, using the machine learning model to generate a graph knowledge base; and
automatically performing at least one of: 1) building the graph knowledge base or 2) enriching an existing knowledge base, using the machine learning model and the one or more meta-tags,
wherein the graph knowledge base comprises at least a graph form of information, wherein the graph knowledge base enables automatic retrieval of organized content to be used for generating teaching material for the user based on the one or more meta-tags.
